(19) United States
(12) Patent Application Publication
(10) Pub. No.: US 2004/0228206 A1
(43) Pub. Date: Nov. 18, 2004

(54) Phase mixing

(76) Inventors: Daniel J. Sadler, Gilbert, AZ (US); Rajnish G. Changrani, Champaign, IL (US); Chia Fu Chou, Chandler, AZ (US); Frederic Zenhausern, Fountain Hills, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/437,574

(22) Filed: May 13, 2003

(51) Int. Cl. B01F 11/02

(52) U.S. Cl. 366/127

(57) ABSTRACT

An exemplary system and method for providing substantially uniform mixing of fluid phases, wherein the frequency of operation, flow velocities and/or device dimensions generally correspond to otherwise substantially diffusion limited applications, is disclosed as comprising inter alia: a mixing chamber; a plurality of electrodes (150) for generating an electric field; an electromagnet (200) for generating a magnetic field; and a controller for oscillating the electric field and the magnetic field in order to produce a periodic frequency-difference phase cycling of the electric and magnetic fields. Disclosed features and specifications may be variously controlled, adapted or otherwise optionally modified to improve mixing operation in any diffusion limited application. Exemplary embodiments of the present invention representatively provide for efficient mixing of fluid phases at relatively high frequencies and may be readily integrated with existing micro-scale technologies for the improvement of device package form factors, weights and other manufacturing and/or device performance metrics.

### FIELD OF INVENTION

The present invention generally concerns systems and methods for uniformly mixing fluid phases wherein the mechanical actuation frequencies, local flow velocities and/or device dimensions generally correspond to Reynolds numbers typically less than about unity; and more particularly, in various representative and exemplary embodiments, to a micro-scale device for mixing at least two liquid, viscous or gaseous.

### BACKGROUND

The mixing of fluids is frequently desired in order to perform chemical reactions. Representatively, a controlled and homogeneous mixing of reagents is generally desirable. In certain applications or operating environments, the combined volume required for the mixture may need to be kept as small as possible so that the consumption of reagents does not become excessive.

A common conventional means of mixing two or more miscible liquids is to stir, either mechanically with a utensil or by exploiting certain fluidic forces, to produce localized regions corresponding to relatively high fluid flow rates that generally operate to produce localized turbulent forces within the fluid field. This turbulence generally provides a relatively large contact surface between the liquids such that diffusion of the fluid components into each other produces a substantially homogeneous mixture. When the flow velocity of a fluid is relatively small, the corresponding Reynolds number R may take on values less than unity as in

$$R = \frac{Ud}{v} < 1 ,$$

where U is the mean flow velocity, d the diameter of the flow channel, and v the kinematic viscosity. Low Reynolds number environments may be encountered, for example, in capillary systems, systems where the device scales are relatively small and/or fluid flow velocities are relatively small, or systems where viscous forces largely dominate the inertial forces produced. In such cases as these, the inertial forces that produce turbulence and the resulting relatively large contact areas generally required to promote mixing typically cannot be achieved. Accordingly, fluid mixing in these types of systems is generally regarded as a diffusion limited process usually requiring the fluid components to remain in relative contact with each other for prolonged periods of time in order to achieve any substantial mixing. For many applications where two or more fluid components are to be mixed and/or dispensed rapidly in the regimen of low Reynolds numbers, this may be unacceptable. Moreover, while pre-mixing of fluid components in certain liquid phase applications may offer an alternative option, pre-mixing of gas phase reaction components is generally not possible. Accordingly, what may be desired is a system and method for the rapid production of substantially homogeneous fluid mixtures in low Reynolds number regimes.

### SUMMARY OF THE INVENTION

In various representative aspects, the present invention provides a system and method for the substantially uniform mixing of fluid phases, wherein the frequency of operation, flow velocities and/or device dimensions generally correspond to otherwise substantially diffusion limited processes. An exemplary system and method for providing such a device is disclosed as comprising inter alia: a mixing chamber; an electrode pattern suitably adapted to generate an electric field within the vicinity of the mixing chamber; an electromagnet suitably adapted to generate a magnetic field within the vicinity of the mixing chamber; and a controller for oscillating the electric field and the magnetic field in order to produce a periodic frequency-difference phase cycling between the electric and magnetic fields. Fabrication of the mixing devices is relatively simple, inexpensive and straightforward. Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 representatively depicts a cross-sectional top view of a mixing device in accordance with an exemplary embodiment of the present invention; and

FIG. 2 generally illustrates another cross-sectional top view of the device representatively depicted in FIG. 1.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms ‘front’, ‘back’, ‘top’, ‘bottom’, ‘over’, ‘under’, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF EXEMPLARY EMBODIMENTS

The following descriptions are of exemplary embodiments of the invention and the inventors' conceptions of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a system and method for mixing at least two liquid, viscous or gaseous phases, is provided as a specific enabling disclosure that may be readily generalized by skilled artisans to any application of the disclosed system and method for uniformly mixing fluid phases where the operational frequencies, flow velocities and/or device dimensions generally correspond to Reynolds numbers less than about unity in accordance with various embodiments of the present invention.

Chemical reactions between different species generally rely upon intimate contact between reacting species. Pre-mixing reactant streams in microfluidic channels for microreactor applications, for example, has been extremely difficult inasmuch as mixing at the micro-scale is primarily governed by diffusion. As a result of difficulties related to pre-mixing reactant streams before they enter, for example, a microreactor, the reactants are usually pre-mixed prior to being supplied into the microfluidic system. However, external pre-mixing, while generally possible in some liquid phase applications, is usually not possible in most gas-phase applications.

Furthermore, the electronic detection of DNA generally requires that single stranded DNA contained in solution be capable of attaching to corresponding complimentary DNA which may be pre-synthesized, for example, on a detection chip. Without active mixing, diffusion is generally the dominant process by which such single stranded molecules in solution may be capable of “finding” and attaching to their complimentary DNA for subsequent detection. If the solution chamber is relatively large, achieving a detectable signal may take up to two hours, depending on the target concentration. Active mixing or stirring of the solution may greatly reduce hybridization times by allowing the fluid particles to traverse the detection region of the chamber much more quickly than by means of diffusion alone. Conventional piezoelectric mixing, however, has been adapted for an optimum operational frequency of about 5 kHz. Being in the audible frequency range, this often produces noise which may be generally unacceptable for a commercial product. Accordingly, in one representative application in accordance with various embodiments of the present invention, methods for improved piezoelectric mixing efficiency with the elimination or otherwise reduced production of audible noise may be desirable.

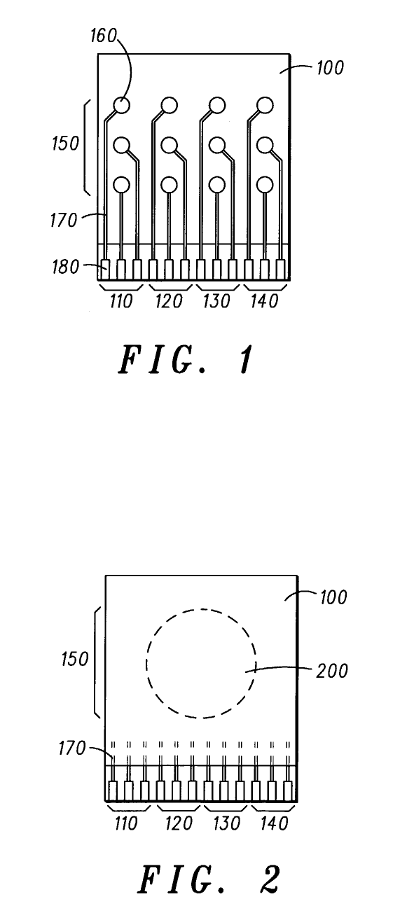

FIG. 1 generally depicts an exemplary device 100, in accordance with one representative aspect of the present invention, to provide a phase-variance method for the mixing of two or more fluids. An electrode pattern 150 comprised of a plurality of electrodes 160 is provided with communicable connection 170 to contact pads 180. Contact pads 180 may be divided into several groups 110, 120, 130, 140 to actuate the production of an electric field in the vicinity of electrode pattern 150. Contact pads 180 may optionally be configured for substantially rapid and/or interchangeable removal and/or replacement of mixing device 100 in, for example, a stand alone controller device, portable hand-held controller device, etc. In any event, however, any type of controller, whether now known or hereafter devised or otherwise described in the art, may be employed to interface with contact pads 180 to produce an electric field in the vicinity of electrode pattern 150.

As shown, for example in FIG. 2, an electromagnet 200 may be disposed substantially within the vicinity of electrode pattern 150 such that a magnetic field may also be produced within the vicinity of the electric field. Contact pads 180 may also be adapted to provide communicable connection of electromagnet 200 with a controller device as well.

Disposition of a mixing chamber within the general vicinity of the electric and magnetic field area generally permits AC electric and magnetic fields of slightly varying frequency to be employed in order to generate “stirring” in both clockwise and counterclockwise directions. The use of AC fields at generally moderate frequencies (for example, above 1 kHz) may be desirable for the prevention of bubble formation and/or electrode degradation. Higher frequencies may be desirable for the reduction of audible noise produced by the device. Accordingly, a mixing method employing electromagnetic phase controlled fluid motion and mixing is provided.

In one exemplary embodiment, substantially perpendicular AC electric and magnetic fields may be employed to generate Lorenz forces on, for example, ions in a fluid solution. The corresponding E-field and H-field may be typically adjusted to slightly different frequencies (e.g., f1=1000 Hz and f2=1001 Hz). This causes the signals to periodically cycle through a phase difference from between about 0 degrees to about 360 degrees at a frequency generally corresponding to the difference between f1 and f2, which promotes a substantially continuous shifting of the mixing direction from clockwise to counterclockwise at low frequency without the problems associated with running conventional magneto hydrodynamic devices at low frequencies. In accordance with one representative embodiment of the present invention, effective mixing of fluid was confirmed by observing the path of 4 μm diameter fluorescent microspheres which were included in the solution.

The magnetohydrodynamic method generally disclosed allows mixing to be achieved on a substantially monolithic substrate by simply patterning additional electrodes for E-field generation on the substrate and attaching a small electromagnet for B-field generation. An additional advantage is that this strategy generally requires no moving parts. Moreover, hybridization times may be significantly reduced with relatively minimal increase in device size and/or complexity.

In other representative and exemplary applications, various embodiments of the present invention may be employed, for example, to mix methanol and water in a reformed hydrogen fuel cell and/or a direct methanol fuel cell.

Additionally, various embodiments of the present invention have demonstrated the capability to mix a variety of fluids including, for example: gases; liquids: gas-liquid mixtures; etc. Other representative applications may include the mixing of fuels supplying a micro-reactor and/or micro-combustion chamber.

Skilled artisans will appreciate that the geometries depicted in the figures are provide for representative and convenient illustration and that many other geometries may be alternatively, conjunctively and/or sequentially employed to produce substantially the same result.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A method for mixing at least two fluid phases, said method comprising the steps of:
providing a first fluid;
providing a second fluid;
providing a mixing chamber;
introducing said first fluid and said second fluid into said mixing chamber;
providing an electric field within the vicinity of said mixing chamber, said electric field comprising a first frequency corresponding to an electric field oscillation;
providing a magnetic field within the vicinity of said mixing chamber, said magnetic field comprising a second frequency corresponding to a magnetic field oscillation;
said first frequency and said second frequency suitably adapted to provide a periodic phase difference.

2. The method according to claim 1, wherein at least one of said fluid phases comprises at least one of a gas, a liquid, a plasma and a viscous material.

3. The method of claim 1, wherein said first frequency and said second frequency are on the order of up to about 5 kHz.

4. The method of claim 1, wherein the vector projection of said electric field and said magnetic field is substantially perpendicular.

5. The method of claim 1, wherein the oscillatory perturbations of said electric field and said magnetic field correspond to an alternating current.

6. The method of claim 1, wherein said phase difference cycles from about 0 degrees to about 360 degrees at a third frequency generally corresponding to the difference between said first frequency and said second frequency.

7. A device for mixing at least two fluid phases, said device comprising:
a mixing chamber;
a pattern comprising a plurality of electrodes, said electrode pattern suitably adapted to generate an electric field within the vicinity of said mixing chamber;
an electromagnet, said electromagnet suitably adapted to generate a magnetic field within the vicinity of said mixing chamber;
a controller, said controller suitably adapted to provide a first oscillation of said electric field corresponding to a first frequency and a second oscillation of said magnetic field corresponding to a second frequency, said controller suitably adapted to provide a periodic phase difference between said first frequency and said second frequency.

8. The device according to claim 7, further comprising a substantially monolithic substrate.

9. The device according to claim 7, wherein said mixing device is substantially integrated with a microfluidic device.
